(19) United States
(12) Patent Application Publication
(10) Pub. No.: US 2011/0186226 A1
(43) Pub. Date: Aug. 4, 2011

(54) GAS SUPPLY MEMBER, PLASMA PROCESSING APPARATUS, AND METHOD OF MANUFACTURING THE GAS SUPPLY MEMBER

(75) Inventors: Kenji Sudou, Hyogo (JP); Naoki Mihara, Hyogo (JP)

(73) Assignee: TOKYO ELECTRON LIMITED, Tokyo (JP)

(21) Appl. No.: 13/062,078

(22) PCT Filed: Aug. 19, 2009
(86) PCT No.: PCT/JP2009/064521

§ 371 Date: Apr. 12, 2011

(30) Foreign Application Priority Data
Sep. 3, 2008 (JP) 2008-226238

(51) Int. Cl. C23F 1/08; H05H 1/24; B32B 37/02; B32B 37/14; B32B 38/10; F15D 1/00

(52) U.S. Cl. 156/345.33; 156/292; 156/256; 137/561 R

(57) ABSTRACT

A gas supply member includes an annular portion in which a passage for a gas extending to have an annular shape is provided. The annular portion includes a first member having an annular shape and including a flat plate portion in which a plurality of gas supply holes through which a gas is supplied are formed, and a second member having an annular shape and forming a space, which becomes the passage for the gas, between the first member and the second member.

### TECHNICAL FIELD

The present invention relates to a gas supply member and a plasma processing apparatus, and more particularly, to a gas supply member that supplies a reaction gas for plasma processing and a plasma processing apparatus that performs plasma processing by supplying the reaction gas into a processing container.

### BACKGROUND ART

A semiconductor device, such as LSI (Large Scale Integrated circuit) or the like, is manufactured by performing a plurality of processes, such as etching, CVD (Chemical Vapor Deposition), sputtering, and the like, on a semiconductor substrate (wafer) that is a substrate to be processed. As for the processes, such as etching, CVD, sputtering, and the like, there are processing methods using plasma as an energy supply source, that is, plasma etching, plasma CVD, plasma sputtering, and the like.

When the aforesaid plasma etching and the like is performed on a substrate to be processed, a reaction gas for processing the substrate to be processed needs to be supplied into a processing container in which plasma is generated. According to Japanese Laid-Open Patent Publication No. hei 6-112163 (Patent Document 1), a plasma processing apparatus using an ECR plasma introduces a gas into a processing container by using a gas introduction nozzle (gas supply member) having a hollow doughnut shape.
[Patent Document 1] Japanese Laid-Open Patent Publication No. hei 6-112163

### DISCLOSURE OF THE INVENTION

### Technical Problem

A conventional gas introduction nozzle (gas supply member) having a hollow doughnut shape as disclosed in Patent Document 1 is generally manufactured by making a quartz pipe (quartz tube) having a cylindrical shape circular and connecting two ends of the quartz pipe to form a circular annular shape, and forming a gas supply hole through which a gas is supplied.

Here, a method of manufacturing the conventional gas supply member having a circular annular shape will be explained. FIG. 16 is a flowchart showing representative processes of the method of manufacturing the conventional gas supply member. As shown in FIG. 16, after a prepared quartz pipe having a cylindrical shape is cut to have a predetermined length, the quartz pipe is bent into a circular annular shape by using manual bending, and ends of the quartz pipe are connected to each other to form an annular portion (FIG. 16 (A)).

Next, annealing (thermal treatment) is performed (FIG. 16 (B)). Next, support portions that support the annular portion, and nozzles that supply a gas into the annular portion from the outside are attached to the annular portion by welding (FIG. 16 (C)).

Next, hydrofluoric acid (HF) cleaning is performed (FIG. 16 (D)), and after fire polishing is performed, annealing is additionally performed (FIG. 16 (E)). Here, the fire polishing refers to a method of planarization by exposing a surface of a material to a flame. Next, gas supply holes through which a gas is supplied are formed at predetermined positions of the annular portion (FIG. 16 (F)). Next, boiling is performed, hydrofluoric acid cleaning is performed again, and a gas supply member is finally obtained (FIG. 16 (G)).

FIG. 17 is a cross-sectional view showing a part of the obtained gas supply member. As shown in FIG. 17, a gas supply member 101 includes a hollow annular portion 102 having a circular annular shape. A cross-section of the annular portion 102 has a circular shape, and a hollow portion 103 becomes a gas passage through which a gas passes in a circumferential direction of the annular portion 102. A gas supply hole 104 obtained by opening a lower part of the annular portion 102 is formed in the annular portion 102. The gas supply hole 104 is formed by manually performing drilling using a laser or drilling using a diamond tool.

Here, when the supply member 101 as shown in FIG. 17 is manufactured as described above, the following problems arise. First, since the annular portion 102 is formed by manual bending, it is very difficult to make the annular portion 102 have a perfect circular shape. Also, since the manual bending is used, a cross-section of a quartz pipe is distorted and fails to have a perfect circular shape, thereby making it difficult to form a plurality of the gas supply holes 104 at precise positions of a curved surface of the annular portion 102. Then, directions in which the plurality of gas supply holes 104 are formed during drilling using a laser become different from one another for each gas supply hole 104. Also, since the thickness of a wall surface of the quartz pipe gets uneven due to the manual bending, uniform conductance in a direction of a gas flowing in the annular gas passage cannot be achieved and uniform conductance in the plurality of gas supply holes 104 cannot be achieved, thereby failing to supply a gas with high precision.

Also, since a stress is applied to the quartz pipe when the quartz pipe is bent into a circular annular shape and the directions in which the plurality of gas supply holes 104 are formed are different from one another as described above, once the gas supply member 101 with such low precision is used in, for example, a plasma processing apparatus, and the gas supply member 101 is cut off while being exposed to plasma and being used, degrees to which the plurality of gas supply holes 104 are corroded are different from one another, thereby making conductance more uneven.

As such, it is difficult to manufacture a gas supply member with high precision in conventional art. Also, if a gas supply member with low precision is used in a plasma processing apparatus, a reaction gas is irregularly supplied into a processing container. Then, it is difficult to perform plasma processing uniformly on a surface of a substrate to be processed. Also, in a plurality of plasma processing apparatuses including the gas supply member 101 with such low precision, a mechanical difference between the plasma processing apparatuses is increased. That is, degrees to which a substrate to be processed is processed are much different between the plasma processing apparatuses.

According to the present invention, there is provided a gas supply member that can uniformly supply a gas.

According to the present invention, there is also provided a plasma processing apparatus that can perform plasma processing uniformly on a surface of a substrate to be processed.

### Technical Solution

According to an embodiment of the present invention, there is provided a gas supply member which supplies a gas, the gas supply member including an annular portion in which a passage for a gas extending to have an annular shape is provided. The annular portion includes a first member having an annular shape and including a flat plate portion in which a plurality of gas supply holes through which a gas is supplied are formed, and a second member having an annular shape and forming the passage between the first member and the second member.

In such a gas supply member, since gas supply holes through which a reaction gas is supplied are formed in a flat plate portion, the gas supply holes can be formed at precise positions or with precise sizes. Also, since an annular portion includes a first member having an annular shape and a second member having an annular shape, it is easy to form a perfect circular shape with respect to the center of the annular portion. Also, since a passage for a reaction gas is formed by the first member having an annular shape and the second member having an annular shape, it is easy to make conductance of the passage for the reaction gas uniform. Accordingly, a gas can be uniformly supplied.

Preferably, the first member and the second member may be bonded to each other.

More preferably, the annular portion may have a circular annular shape.

Also, a cross-section of the second member may have a substantially ␣ shape.

More preferably, the plurality of the gas supply holes may be formed at regular intervals in a circumferential direction.

More preferably, materials of the first and second members may be quartz.

According to another embodiment of the present invention, there is provided a plasma processing apparatus including: a processing container in which plasma processing is performed to be performed on a substrate to be processed; a holding stage which is disposed in the processing container and holds the substrate to be processed thereon; a plasma generating unit which generates a plasma in the processing container; and a gas supply member which supplies a reaction gas for plasma processing into the processing container. The gas supply member includes an annular portion in which a passage for a gas extending to have an annular shape is provided. Here, the annular portion includes a first member having an annular shape and including a flat plate portion in which a plurality of gas supply holes through which a gas is supplied are formed, and a second member having an annular shape and forming the passage between the first member and the second member.

Since such a plasma processing apparatus includes a gas supply member that can uniformly supply a gas, the plasma processing apparatus can perform plasma processing uniformly on a surface of a substrate to be processed by uniformly supplying a reaction gas into a processing container.

More preferably, the plasma generating unit may include a microwave generator which generates a microwave for plasma excitation, and a dielectric plate which is disposed to face the holding stage and through which the microwave is introduced into the processing container.

### Advantageous Effects

According to such a gas supply member, since gas supply holes through which a reaction gas is supplied are formed in a flat plate portion, positions or sizes of the gas supply holes can be determined with high precision. Also, since an annular portion includes a first member having an annular shape and a second member having an annular shape, it is easy to form a perfect circular shape with respect to the center of the annular portion. Also, a passage for a reaction gas is formed by the first member having an annular shape and the second member having an annular shape, it is easy to make conductance of the passage for the reaction gas uniform. Accordingly, a gas can be uniformly supplied.

Also, according to such a plasma processing apparatus, since the plasma processing apparatus includes a gas supply member capable of uniformly supplying a gas, the plasma processing apparatus can perform plasma processing uniformly on a surface of a substrate to be processed by uniformly supplying a reaction gas into a processing container.

### BRIEF DESCRIPTION OF THE DRAWINGS

FIG. 1 is a view showing a gas supply member according to an embodiment of the present invention.

FIG. 2 is a cross-sectional view taken along line II-II of the gas supply member shown in FIG. 1.

FIG. 3 is a flowchart showing representative processes of a method of manufacturing the gas supply member, according to an embodiment of the present invention.

FIG. 4 is a view showing a state where a flat plate member having an annular shape is cut off from a flat plate-shaped member.

FIG. 5 is a view of the cut flat plate member having an annular shape, seen in a plate thickness direction.

FIG. 6 is a view of a second member seen in the plate thickness direction.

FIG. 7 is a cross-sectional view of the second member taken along line VII-VII shown in FIG. 6.

FIG. 8 is a view of a first member seen in the plate thickness direction.

FIG. 9 is a cross-sectional view of the first member taken along line IX-IX shown in FIG. 8.

FIG. 10 is a view showing a state where the first member and the second member are combined to each other.

FIG. 11 is a schematic cross-sectional view showing main parts of a plasma processing apparatus according to an embodiment of the present invention.

FIG. 12 is a cross-sectional view showing a part of a gas supply member according to another embodiment of the present invention.

FIG. 13 is a cross-sectional view showing a part of a gas supply member according to yet another embodiment of the present invention.

FIG. 14 is a cross-sectional view showing a part of a gas supply member according to yet another embodiment of the present invention.

FIG. 15 is a cross-sectional view showing a part of a gas supply member according to yet another embodiment of the present invention.

FIG. 16 is a flowchart showing representative processes of a method of manufacturing a conventional gas supply member.

FIG. 17 is a cross-sectional view showing a part of the conventional gas supply member.

### BEST MODE FOR CARRYING OUT THE INVENTION

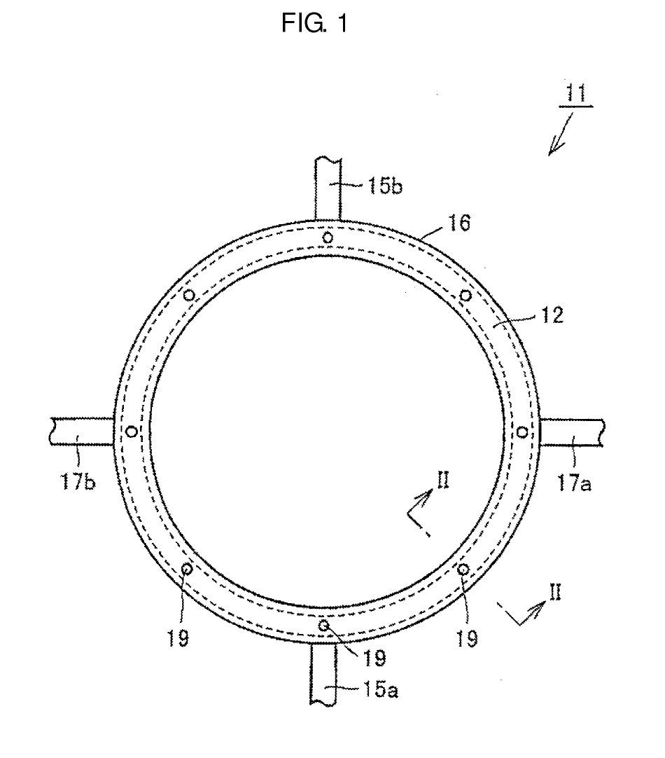

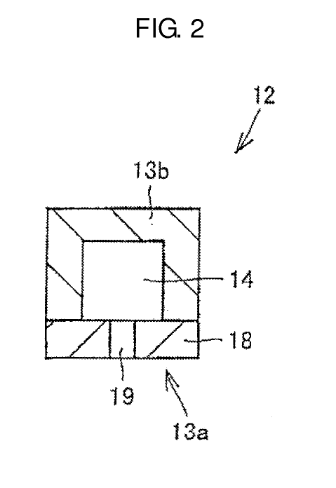

Hereinafter, embodiments of the present invention will be explained with reference to the drawings. FIG. 1 is a view showing main parts of a gas supply member according to an embodiment of the present invention. FIG. 2 is a cross-sectional view taken along line II-II of FIG. 1.

As shown in FIGS. 1 and 2, a gas supply member 11 includes an annular portion 12 having a circular annular shape. The annular portion 12 is hollow. That is, in the annular portion 12, a space 14 extending to have an annular shape is formed by a first member 13a having an annular shape and a second member 13b having an annular shape which will be explained later.

The gas supply member 11 includes one pair of nozzles 15a and 15b that supply a gas into the annular portion 12. The nozzles 15a and 15b are hollow. The nozzles 15a and 15b are provided to straightly extend from an outer diameter surface 16 of the annular portion 12 to an outer diameter side. A gas is supplied through the nozzles 15a and 15b into the annular portion 12 from the outside of the annular portion 12, specifically, into the space 14 that becomes a passage for a gas in the annular portion 12. The one pair of nozzles 15a and 15b are disposed to face each other at positions separated by 180 degrees.

Also, the gas supply member 11 includes one pair of support portions 17a and 17b that support the annular portion 12. The one pair of support portions 17a and 17b are also provided to straightly extend from the outer diameter surface 16 of the annular portion 12 to the outer diameter side. The one pair of support portions 17a and 17b are disposed to face each other at positions separated by 180 degrees. Ends (not shown) of the support portions 17a and 17b at the outer diameter side are attached and fixed to another member. For example, the ends of the support portions 17a and 17b at the outer diameter side are fixed to a side wall of a processing container of a plasma processing apparatus that will be explained later. The one pair of support portions 17a and 17b support the annular portion 12 at predetermined places of another member. Also, the one pair of support portions 17a and 17b and the one pair of nozzles 15a and 15b are disposed on the outer diameter surface 16 of the annular portion 12 at about 90-degree intervals.

Here, a detailed configuration of the annular portion 12 will be explained. The annular portion 12 includes the first member 13a having an annular shape and the second member 13b having an annular shape. Materials of the first and second members 13a and 13b are quartz. The annular portion 12 is formed by bonding the first member 13a and the second member 13b.

The first member 13a includes a flat plate portion 18 having an annular flat plate shape. A plurality of, specifically, eight, gas supply holes 19 through which a gas is supplied are formed in the flat plate portion 18. The eight gas supply holes 19 are formed by making holes at predetermined places of the flat plate portion 18 by using a laser. The gas supply holes 19 each have a round hole shape. The eight gas supply holes 19 are formed in the flat plate portion 18 having the annular shape at regular intervals in a circumferential direction. That is, the eight gas supply holes 19 are formed at regular intervals in the circumferential direction of the flat plate portion 18 having the annular shape.

A cross-section of the second ember 13b has a substantially [symbol] shape. That is, the second member 13b has a shape obtained by combining two cylindrical members having different diameters with one member having the same shape as that of the above flat plate portion 18.

The space 14 having an annular shape is formed between the first member 13a having an annular shape and the second member 13b having an annular shape. In the cross-section shown in FIG. 2, the space 14 has a substantially rectangular shape. The space 14 becomes a passage for a gas which extends in the circumferential direction in the annular portion 12.

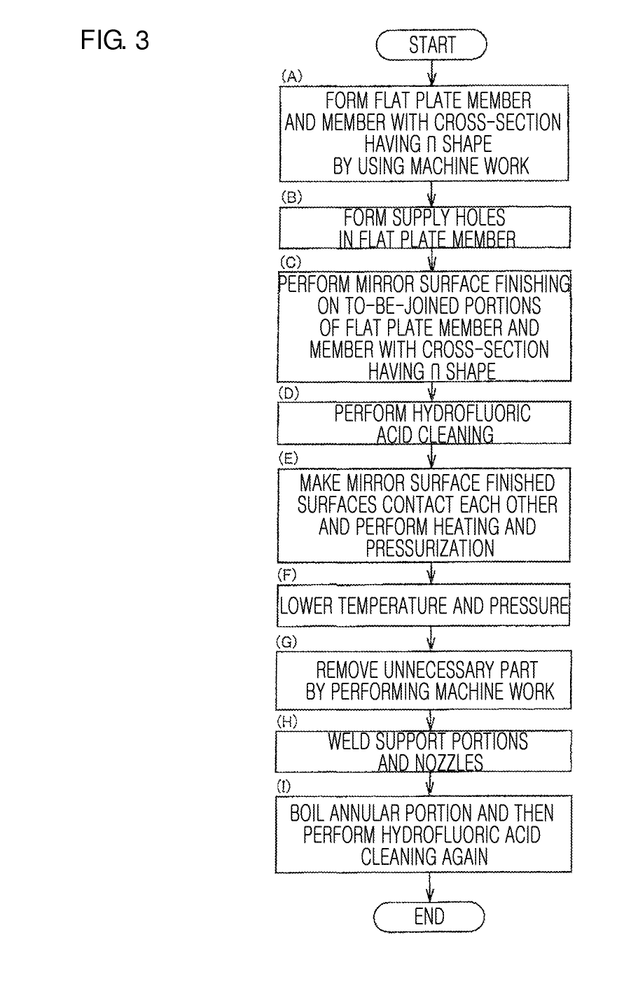

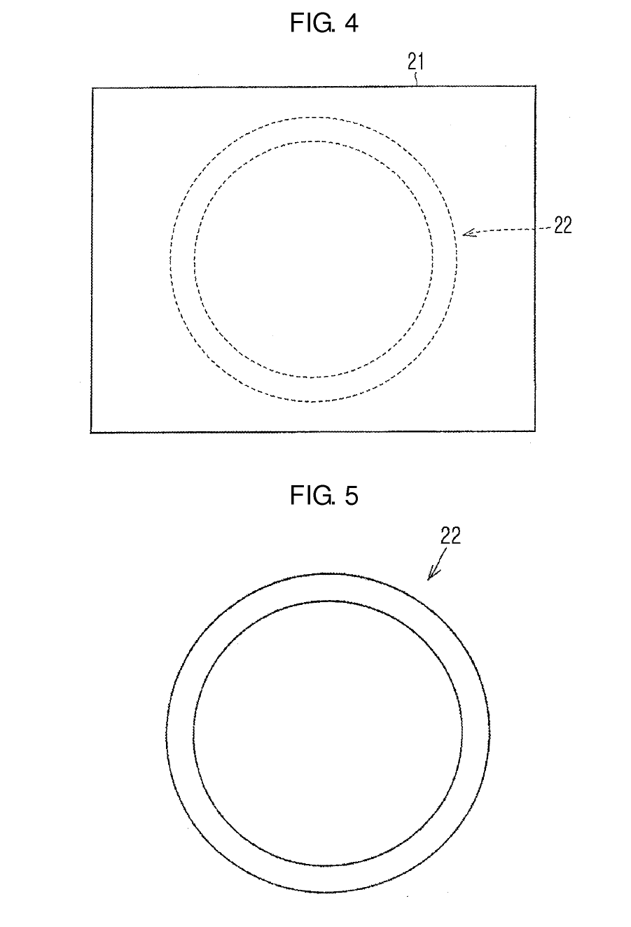

Next, a method of manufacturing the above gas supply member 11 will be explained. FIG. 3 is a flowchart showing representative processes of a method of manufacturing the gas supply member 11 according to an embodiment of the present invention. Also, FIGS. 4 through 10 are views for explaining the manufacturing processes of the gas supply member 11.

First, a flat plate-shaped member is prepared. Next, a part of the flat plate-shaped member 21 shown in FIG. 4 is cut off to have an annular shape as indicated by dotted lines. As such, a flat plate-shaped member 22 having an annular shape as shown in FIG. 5 is formed. This process is performed on the flat plate-shaped member 21 and a flat plate-shaped member with a thickness different from that of the flat plate-shaped member 21 to form outer shapes of a first member and a second member.

Next, machine work is performed on the flat plate-shaped member 22 having a greater plate thickness such that a cross-section of the flat plate-shaped member 22 has a substantially [symbol] shape. In this case, specifically, one surface side of the flat plate-shaped member 22 in a plate thickness direction is cut off to have a substantially [symbol] shape.

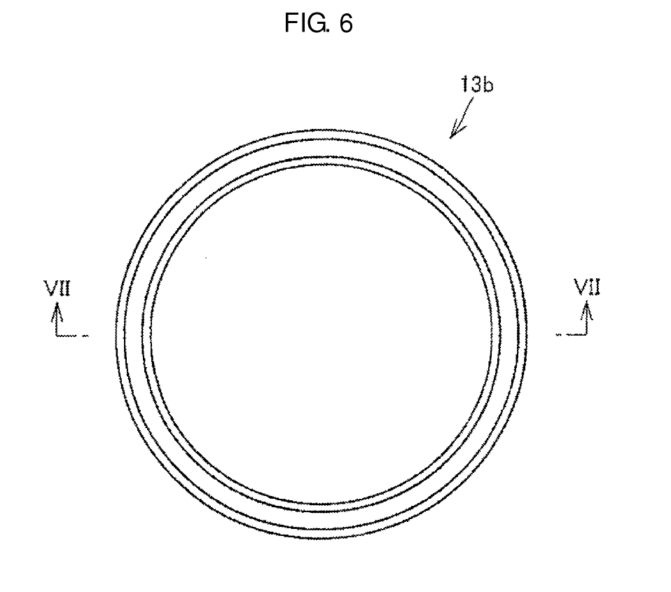

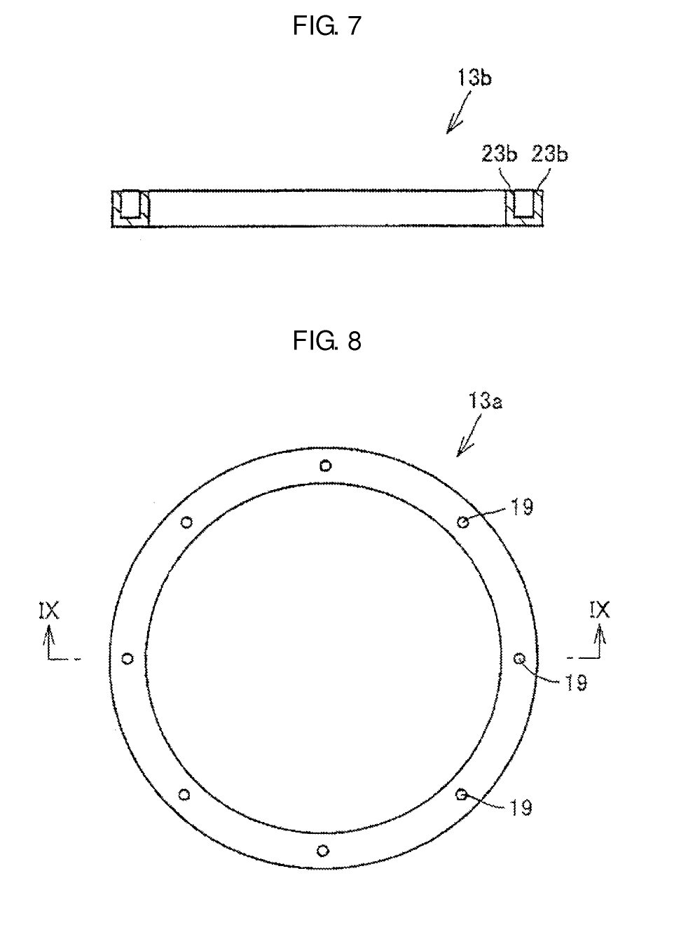

As such, the annular second member 13b with a cross-section having a [symbol] shape as shown in FIGS. 6 and 7 is formed (FIG. 3 (A)). Also, FIG. 6 is a view of the second member 13b seen in the plate thickness direction, and FIG. 7 is a cross-sectional view of the second member 13b taken along line VII-VII of FIG. 6.

Meanwhile, eight gas supply holes 19 through which a gas is supplied are formed in the flat plate-shaped member 22 having a smaller plate thickness by using a laser (FIG. 3 (B)). In this case, because the object is the flat plate-shaped member 22, it is easy to adjust a focus depth of the laser. Also, due to the flat plate-shaped member 22, directions in which the gas supply holes 19 are formed by drilling using the laser are uniform. Also, since the flat plate-shaped member 22 having an annular shape is not bent, the gas supply holes 19 can be formed with high precision. Also, conductance of each of the gas supply holes 19 can be uniform.

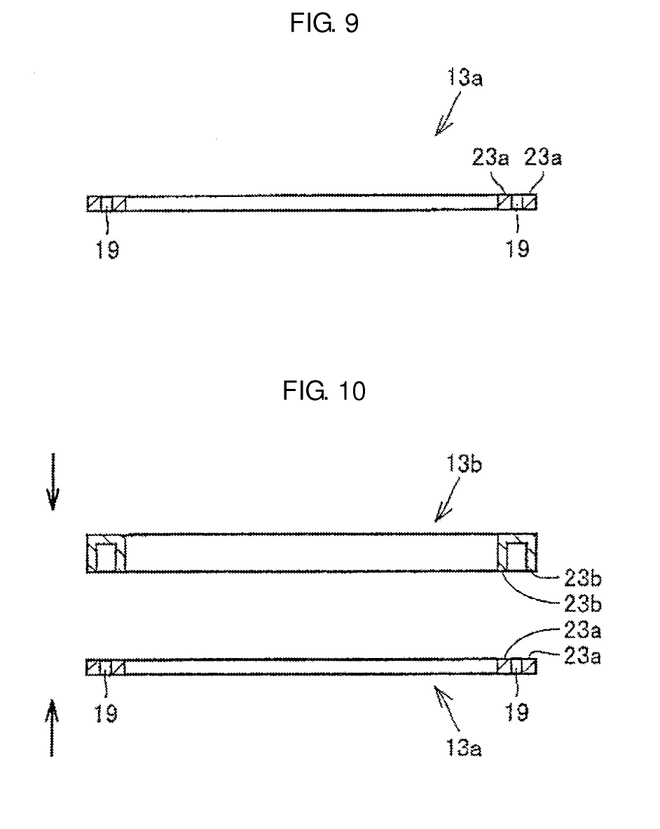

As such, the first member 13a in which the eight gas supply holes 19 shown in FIGS. 8 and 9 are formed is formed. FIG. 8 is a view of the first member 13a seen in the plate thickness direction, and FIG. 9 is a cross-sectional view of the first member 13a taken along line IX-IX of FIG. 8. The eight gas supply holes 19 are formed at regular intervals in a circumferential direction. Also, the flat plate-shaped member 22 becomes the flat plate portion 18 included in the first member 13a having an annular shape.

Next, mirror surface finishing is performed on to-be-bonded portions of the first member 13a and the second member 13b (FIG. 3 (C)). The to-be-bonded portions are an area 23b of the second member 13b shown in FIG. 7, and an area 23a of the first member 13a shown in FIG. 9.

Next, hydrofluoric acid (HF) cleaning is performed on the first and second members 13a and 13b (FIG. 3 (D)). That is, each of the first and second members 13a and 13b is cleaned using hydrofluoric acid. In this case, since hydrofluoric acid cleaning can be performed on each of the first and second members 13a and 13b, a wall surface at the space 14 which becomes a gas passage later can be easily cleaned. Accordingly, cleaning can be performed easily and thoroughly.

Next, the first member 13a and the second member 13b are moved in directions indicated by arrows of FIG. 10 to approach each other as shown in FIG. 10 such that the area 23a of the first member 13a and the area 23b of the second member 13b contact each other, and heating and pressurization are performed to bond the first member 13a and the second member 13b (FIG. 3 (E)).

The bonding between the first member 13a and the second member 13b is finished by lowering a temperature and a pressure (FIG. 3 (F)), and an unnecessary part is removed by performing machine work (FIG. 3 (G)).

Next, the nozzles 15a and 15b and the support portions 17a and 17b are attached by welding to the annular portion 12 that is formed by bonding the first member 13a and the second member 13b (FIG. 3 (H)).

Finally, after the annular portion 12 to which the nozzle 15a and the like are attached is boiled, hydrofluoric acid cleaning is performed again (FIG. 3 (I)). The gas supply member 11 is obtained in this manner.

According to the gas supply member 11, since the gas supply holes 19 through which a reaction gas is supplied are formed in the flat plate portion 18, positions or sizes of the gas supply holes 19 can be determined with high precision. Also, since the annular portion 12 includes the first member 13a having an annular shape and the second member 13b having an annular shape, it is easy to form a perfect circular shape with respect to the center of the annular portion 12. Also, since a passage for a reaction gas is formed by the first member 13a and the second member 13b, it is easy to make conductance of the passage for the reaction gas uniform. Accordingly, a gas can be uniformly supplied.

Also, in the above embodiment, although the gas supply holes 19 are formed by drilling using a laser, the present invention is not limited thereto, and the gas supply holes 19 may be formed by drilling using a diamond tool.

Next, a configuration of a plasma processing apparatus including the gas supply member 11 according to the aforesaid embodiment of the present invention will be explained.

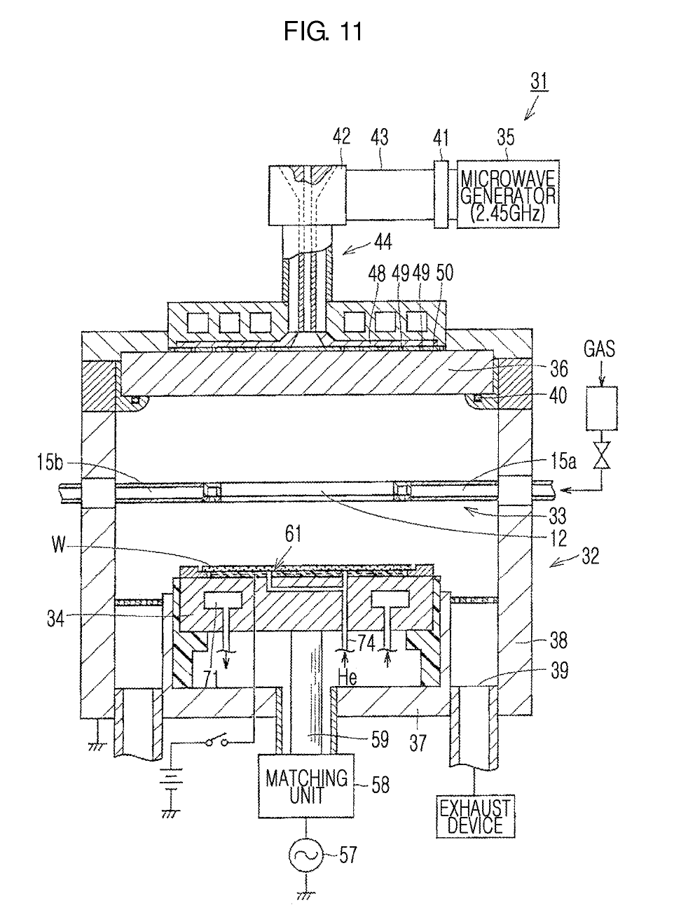

FIG. 11 is a schematic cross-sectional view showing main parts of the plasma processing apparatus including the gas supply member 11 according to an embodiment of the present invention. As shown in FIG. 11, a plasma processing apparatus 31 includes a processing container 32 in which plasma processing is performed on a substrate W to be processed, a reaction gas supply unit 33 which supplies a reaction gas for plasma processing into the processing container 32, a holding stage 34 which has a circular plate shape and holds the substrate W to be processed thereon, a plasma generating unit which generates plasma in the processing container, and a controller (not shown) which controls the entire plasma processing apparatus 31. The controller controls process conditions, under which plasma processing is performed on the substrate W to be processed, such as a gas flow rate in the reaction gas supply unit 33, a pressure in the processing container 32, and so on. The plasma generating unit includes a microwave generator 35 which generates a microwave for plasma excitation, and a dielectric plate 36 which is disposed to face the holding stage 34 and through which a microwave generated by the microwave generator 35 is introduced into the processing container 32.

The processing container 32 includes a bottom portion 37 which is located under the holding stage 34, and a side wall 38 which extends upward from an outer circumference of the bottom portion 37. The side wall 38 has a cylindrical shape. An exhaust hole 39 for exhaust is formed in the bottom portion 37 of the processing container 32. An upper side of the processing container 32 is opened, and the processing container 32 can be sealed by the dielectric plate 36 that is disposed at an upper side of the processing container 32 and an O-ring 40 that is a sealing member disposed between the dielectric plate 36 and the processing container 32.

The microwave generator 35 including a matching 41 is connected to an upper portion of a coaxial waveguide 44 through which a microwave is introduced, with a mode converter 42 and a waveguide 43 interposed therebetween. A frequency of a microwave generated by the microwave generator 35 may be, for example, 2.45 GHz.

The dielectric plate 36 has a circular plate shape and is formed of a dielectric substance. A lower side of the dielectric plate 36 is flat. Also, a detailed material of the dielectric plate 36 may be quartz, aluminum, or the like.

Also, the plasma processing apparatus 31 includes a wavelength-shortening plate 48 through which a microwave introduced by the coaxial waveguide 44 is propagated, and a slot antenna 50 which has a thin circular plate shape and by which a microwave is introduced to the dielectric plate 36 through a plurality of slot holes 49. A microwave generated by the microwave generator 35 passes through the coaxial waveguide 44, is propagated to the wavelength-shortening plate 48, and is introduced to the dielectric plate 36 through the plurality of slot holes 49 formed in the slot antenna 50. The microwave having passed through the dielectric plate 36 generates an electric field right under the dielectric plate 36 to generate plasma in the processing container 32.

A high frequency power source 57 for RF bias is electrically connected to the holding stage 34 with a matching unit 58 and a power feed bar 59 interposed therebetween. An electrostatic chuck 61 for holding the substrate W to be processed by using an electrostatic adsorption force is provided on a top surface of the holding stage 34. A gas supply pipe 74 or a coolant chamber 71 having an annular shape and extending in a circumferential direction is provided in the holding stage 34. Due to the coolant chamber 71 and the gas supply tube 74, a processing temperature of the substrate W to be processed on the electrostatic chuck 61 can be controlled.

Here, the reaction gas supply unit 33 will be explained. The reaction gas supply unit 33 includes the above-described gas supply member 11. The annular portion 12 included in the gas supply member 11 is disposed over the substrate W to be processed between the holding stage 34 and the dielectric plate 36 in the processing container 32. The annular portion 12 is fixed to the inside of the processing container 32 by the one pair of support portions 17a and 17b. In detail, the annular portion 12 is fixed to the inside of the processing container 32 by attaching ends of the outer diameter sides of the support portions 17a and 17b to the side wall 38. Also, the one pair of nozzles 15a and 15b are also attached to the side wall 38. Also, FIG. 11 is a cross-sectional view including the nozzles 15a and 15b included in the gas supply member 11.

A reaction gas for plasma processing supplied from the outside of the processing container 32 is supplied into the gas supply member 11 through the nozzles 15a and 15b. The supplied reaction gas is uniformly supplied into the processing container 32 by the gas supply member 11. In detail, the supplied reaction gas is uniformly supplied with respect to each position on the substrate W to be processed.

Next, a method of performing plasma processing on the substrate W to be processed by using the plasma processing apparatus 31 according to an embodiment of the present invention will be explained.

First, the substrate W to be processed is held on the holding stage 34, which is provided in the processing container 32, by using the electrostatic chuck 61. Next, a microwave for plasma excitation is generated by the microwave generator 35. Next, the microwave is introduced into the processing container 32 by using the dielectric plate 36 or the like. After that, the gas supply member 11 included in the reaction gas supply unit 33 supplies a reaction gas to the substrate W to be processed in the processing container 32. As such, plasma processing is performed on the substrate W to be processed.

Since the plasma processing apparatus 31 includes the gas supply member 11 that can uniformly supply a gas, the plasma processing apparatus 31 can perform plasma processing uniformly on a surface of the substrate W to be processed by uniformly supplying a reaction gas into the processing container 32. Also, since the gas supply member 11 has high precision, a mechanical difference between a plurality of the plasma processing apparatuses 31 can be reduced.

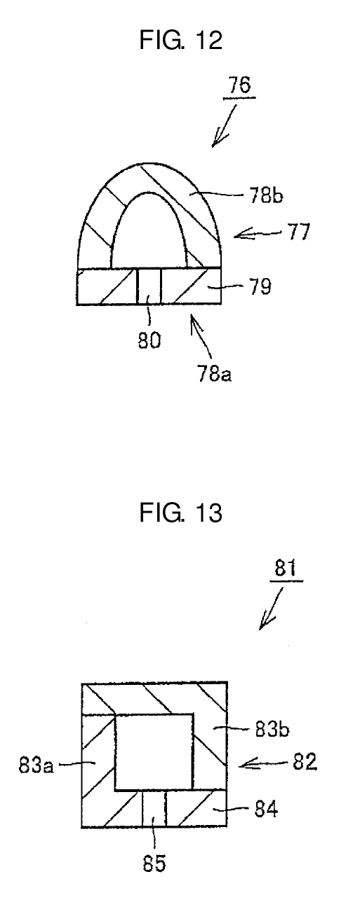

Also, in the above embodiment, although a cross-section of the second member has a substantially [symbol] shape, the present invention is not limited thereto, and the cross-section of the second member may have a substantially U shape. That is, as shown in FIG. 12, an annular portion 77 included in a gas supply member 76 may include a first member 78a including a flat plate portion 79 in which gas supply holes 80 are formed, and a second member 78b with a cross-section having a substantially U shape.

Also, as shown in FIG. 13, in an annular portion 82 included in a gas supply member 81, a cross-section of a first member 83a including a flat plate portion 84 may have a substantially L shape. Also, a cross-section of a second member 83b may have a substantially L shape. In this case, gas supply holes 85 are formed in the flat plate portion 84.

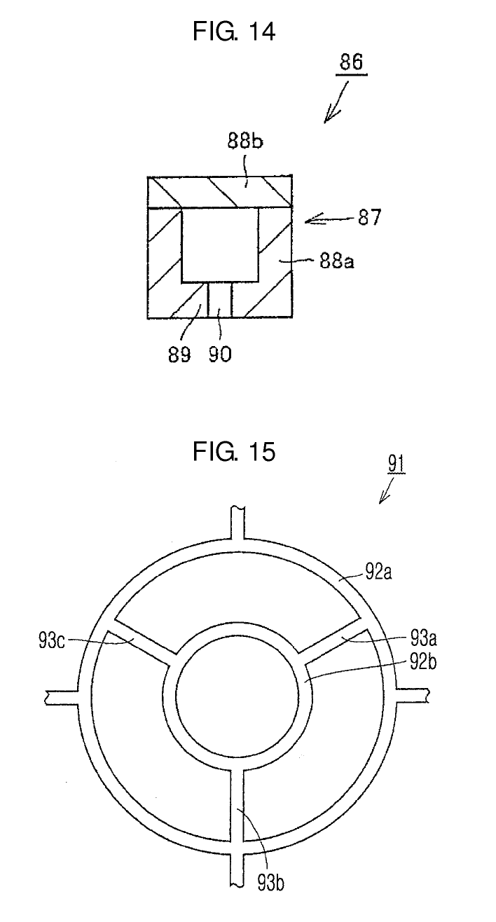

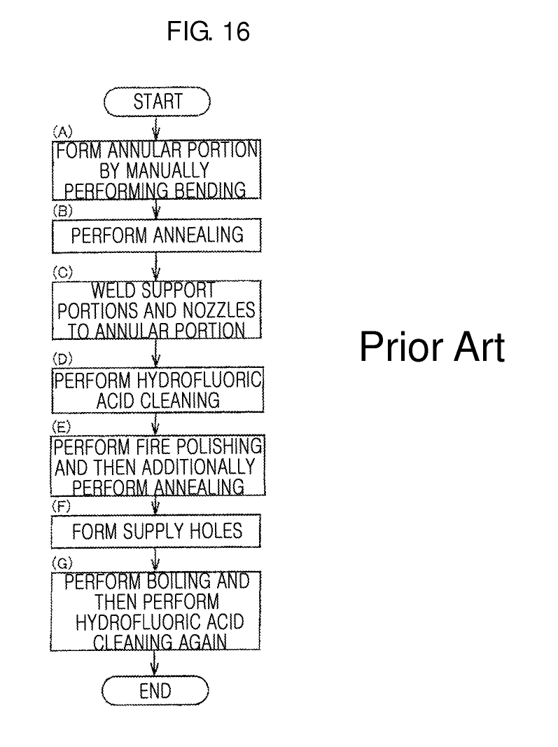

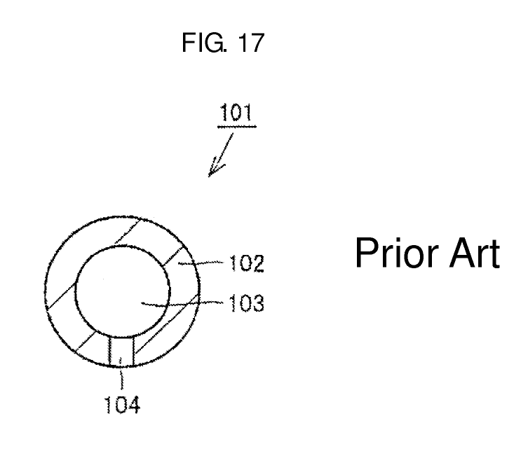

Also, as shown in FIG. 14, in an annular portion 87 included in a gas supply member 86, gas supply holes 90 may be formed in a flat plate portion 89 included in a first member 88a with a cross-section having a substantially [symbol] shape. In this case, a second member 88b has a flat plate shape.

Also, in the above embodiment, two annular portions may be included in a gas supply member and the gas supply member may be formed twofold. FIG. 15 is a view showing a part of a gas supply member 91 in this case, which corresponds to FIG. 1. As shown in FIG. 15, the gas supply member 91 includes first and second annular portions 92a and 92b. Each of the first and second annular portions 92a and 92b is disposed in a concentric shape. The first annular portion 92a is disposed at an outer diameter side than the second annular portion 92b. That is, a diameter of the first annular portion 92a is larger than a diameter of the second annular portion 92b. The first annular portion 92a and the second annular portion 92b are connected to each other by three nozzles 93a, 93b, and 93c which are provided at regular intervals in a circumferential direction. The nozzles 93a through 93c support the second annular portion 92b, and a gas is supplied from the first annular portion 92a. A space formed by a first member and a second member is formed in each of the first and second annular portions 92a and 92b. This space becomes a passage for a reaction gas in each of the first and second annular portions 92a and 92b.

In this configuration, a gas can be uniformly supplied. Also, three or more annular portions may be included in a gas supply member and the gas supply member may be formed threefold or more. Also, in FIG. 15, gas supply holes through which a gas is supplied are not shown.

Also, in the above embodiment, although a first member and a second member are bonded to each other, the present invention is not limited thereto, and the first member and the second member may be adhered to each other, and another member may be interposed between the first member and the second member.

Also, in the above embodiment, although an annular portion has a circular annular shape, the present invention is not limited thereto, and the annular portion may include a part having a straight line shape. Also, the annular portion may have an oval shape.

Also, in the above embodiment, although each of the first member and the second member is formed by using one member, the present invention is not limited thereto, and the first member or the second member may be configured by combining a plurality of members. That is, for example, the second member with a cross-section having a substantially [symbol] shape may be formed by combining two cylindrical members with different diameters and one flat plate-shaped member. Also, the first member and the second member may be configured by combining a plurality of members having circular arc shapes divided in a circumferential direction.

Also, in the above embodiment, although nozzles and support portions included in a gas supply member straightly extend toward the outer diameter side, the present invention is not limited thereto, and the nozzles and the support portions may include portions extending in a plate thickness direction of a plane including an annular portion, that is, in a direction perpendicular to the drawing sheet of FIG. 1. As such, when the annular portion is disposed in, for example, the plasma processing apparatus, the annular portion can be disposed at an appropriate position above the substrate W to be processed.

Also, in the above embodiment, although a gas supply member includes two nozzles and two support portions, that is, four portions in total, the present invention is not limited thereto, and four nozzles, three nozzles, or five nozzles may be provided. Also, other number of nozzles and support portions may be provided.

Also, in the above embodiment, although 8 gas supply holes are formed, the present invention is not limited thereto, and, for example, 16, 32, or other number of gas supply holes may be formed.

Also, in the above embodiment, although a lower side of a dielectric plate included in a plasma processing apparatus is flat, the present invention is not limited thereto, and a recess portion having a tapered shape may be provided. That is, a lower portion of the dielectric plate may have a uneven shape. As such, plasma can be efficiently generated by using a microwave under the dielectric plate.

Also, in the above embodiment, although the plasma processing apparatus uses a microwave as a plasma source, the present invention is not limited thereto, and a plasma processing apparatus may use ICP (Inductively-coupled Plasma), ECR (Electron Cyclotron Resonance) plasma, a parallel flat plate-type plasma, or the like as a plasma source.

Also, in the above embodiment, although a gas supply member is applied to the plasma processing apparatus, the present invention is not limited thereto, and a gas supply member according to the present application can be applied to any apparatus that requires uniform supply of a gas.

While the present invention has been particularly shown and described with reference to exemplary embodiments thereof, but the present invention is not limited thereto. It will be understood by those of ordinary skill in the art that various changes in form and details may be made therein without departing from the spirit and scope of the present invention as defined by the following claims.

### INDUSTRIAL APPLICABILITY

A gas supply member according to the present invention is effectively used in a plasma processing apparatus that is required to supply a gas uniformly.

A plasma processing apparatus according to the present invention is effectively used to uniformly supply a reaction gas into a processing container.

1. A gas supply member which supplies a gas, the gas supply member comprising:
an annular portion having a plurality of gas supply holes;
a support portion located outside of the annular portion; and
a nozzle portion located outside of the annular portion to supply a gas to the annular portion,
wherein the annular portion comprises:
a first member comprised of a flat plate portion; and
a second member being bonded to the first member to form a gas passage between the first member and the second member.

2. The gas supply member of claim 1, wherein a cross-section of the second member has a substantially [symbol] or U shape.

3. The gas supply member of claim 1, wherein the plurality of gas supply holes through which the gas is supplied are formed in a member whose cross-section has a substantially [symbol] or U shape.

4. The gas supply member of claim 1, wherein the plurality of gas supply holes through which the gas is supplied are formed in the first member.

5. The gas supply member of claim 1, wherein the plurality of gas supply holes are formed at regular intervals in a circumferential direction.

6. The gas supply member of claim 1, wherein materials of the first and second members are quartz.

7. A plasma processing apparatus comprising:
a processing container in which plasma processing is performed on a substrate to be processed;
a holding stage which is disposed in the processing container and holds the substrate to be processed thereon;
a plasma generating unit which generates a plasma in the processing container; and
a gas supply member which supplies a reaction gas for plasma processing into the processing container,
wherein the gas supply member comprises:
an annular portion having a plurality of gas supply holes;
a support portion located outside of the annular portion to fix the gas supply member to the processing container; and
a nozzle portion located outside of the annular portion to supply a gas to the annular portion; and
wherein the annular portion comprises:
a first member composed of a flat plate portion; and
a second member being bonded to the first member to form a gas passage between the first member and the second member.

8. The plasma processing apparatus of claim 7, wherein the plasma generating unit comprises a microwave generator which generates a microwave for plasma excitation, and a dielectric plate which is disposed to face the holding stage and through which the microwave is introduced into the processing container.

9. The plasma processing apparatus of claim 1, wherein both cross-sections of the first and the second members have substantially L shape.

10. A method of manufacturing a gas supply member, the gas supply member comprising: an annular portion having a plurality of gas supply holes; a support portion located outside of the annular portion; and a nozzle portion located outside of the annular portion to supply a gas to the annular portion,
the method comprising: forming the gas supply member by bonding a first member, which comprises a flat plate, and a second member, which forms the passage between the first member and the second member, to each other.

11. The method of manufacturing a gas supply member of claim 10, the method comprising:
preparing two flat plate-shaped members whose thicknesses are different from each other,
forming a first member and a second member by cutting off the two flat plate-shaped members;
processing the second member whose plate thickness is greater such that a cross-section of the second member has a substantially [symbol] or U shape, by cutting one surface the second member in a plate thickness direction of a flat plate-shaped member; and
bonding the first and second members to each other to form a passage for a gas.

12. The method of manufacturing a gas supply member of claim 10, wherein materials of the first and second members are quartz.

13. The method of manufacturing a gas supply member of claim 10, wherein a cross-section of the second member has a substantially [symbol] or U shape.
